(19) United States
(12) Patent Application Publication
(10) Pub. No.: US 2013/0235218 A1
(43) Pub. Date: Sep. 12, 2013

(54) Virtual Gravestone

(71) Applicant: ANGELBOOK LLC, Salem, OH (US)

(72) Inventors: Kenneth H. Cathcart, II, Lehighton, PA (US); Daniel C. Cresap, Smithville, MS (US); Joseph J. Korff, Jupiter, FL (US)

(73) Assignee: ANGELBOOK LLC, Salem, OH (US)

(21) Appl. No.: 13/788,219

(22) Filed: Mar. 7, 2013

Related U.S. Application Data
(60) Provisional application No. 61/608,236, filed on Mar. 8, 2012.

(51) Int. Cl. H04N 5/232

(52) U.S. Cl. CPC H04N 5/23203
USPC 348/207.1

(57) ABSTRACT

A system for remotely perceiving images and sounds associated with a gravestone, including a gravestone, a power source, a camera, a video screen, at least one speaker, a computer, a database, a website, and an internet connection.

### TECHNICAL FIELD

The subject disclosure generally relates to a method and system of transmitting images of a gravestone to a user over the internet. A user may control certain aspects of the viewing experience.

### BACKGROUND

A video enhanced gravemarker is disclosed in U.S. Pat. No. 7,089,495 to Barrows. The disclosure of barrows teaches a tombstone for communicating audio and visual data related to the deceased from the tombstone to a user, the tombstone comprising an indicia bearing and viewing portion, a visual display, an audio transmitter for communicating sound waves to a user, data related to the deceased, the data comprising audio and visual images of the deceased, the data stored within storage media, and means for reproducing the audio and visual images of the deceased from the data related to the deceased utilizing one or more players, readers or drivers for the one or more of the storage media.

The Barrows disclosure does not contemplate transmission over the internet or social networking.

### SUMMARY OF THE INVENTION

The invention relates to a system for remotely perceiving images and sounds associated with a gravestone, the area adjacent to the gravestone, comprising: (a) a gravestone, (b) a power source, (c) a camera, (d) a wireless internet transceiver, (e) a video screen, (f) a speaker, (g) a computer, (h) a database, (i) a website, and (j) an internet connection. The power source, speaker, wireless internet transceiver, and camera, are operatively connected together in a housing proximate the gravestone. The computer, video screen, database, website and camera are operatively connected such that commands entered into the computer are transmitted through at least one of the website and the wireless internet transceiver to effect control of the camera. The database is capable of storing snapshots or videos perceived by the camera and other data entered by the user into the computer and transmitted through at least one of the website and the wireless internet transceiver to the computer and the attached video screen.

An embodiment of the invention is a method of transmitting images and sounds from a gravestone area to a user comprising: (a) providing a camera in the vicinity of a gravestone, (b) providing and operatively connecting together a power source, speaker, wireless internet transceiver, and camera, in a housing proximate the gravestone, (c) providing an internet connection, to which the camera and a computer are operatively connected, (d) operating the camera to perceive and at least temporarily store images of the gravestone, (e) transmitting images from the camera through the wireless internet transceiver to the internet, and (f) operating a website operatively connected to the internet in order to transmit and display images perceived by the camera to the computer making them visible to the user.

An embodiment of the invention is a method of presenting at least one of images and sounds of a person comprising: (a) recording at least one of images and sounds of a person, (b) storing the at least one of images and sounds on a server accessible to the internet, (c) providing and operatively connecting together a power source, at least one of a speaker and a video screen, and wireless internet transceiver proximate a gravestone, (d) providing a control switch by which a user may control the playback of at least one of a speaker and video screen, (e) providing a website, to which the computer, at least one of a speaker and a video screen and a computer are operatively connected, and (f) operating (1) the control switch or (2) the website to command the server to play back the at least one of images and sounds either on the computer screen or on the at least one of speaker and video screen proximate the gravestone.

### BRIEF DESCRIPTION OF THE DRAWINGS

FIG. 1 depicts an embodiment of the invention.

FIG. 2 depicts an embodiment of the invention.

FIG. 3 is a conceptual map of an embodiment of the invention.

### DETAILED DESCRIPTION OF THE INVENTION

The invention relates to a system for remotely perceiving images and sounds associated with a gravestone, the area adjacent to the gravestone, comprising: (a) a gravestone, (b) a power source, (c) a camera, (d) a wireless internet transceiver, (e) a video screen, (f) a speaker, (g) a computer, (h) a database, (i) a website, and (j) an internet connection. The system is designed so that a remotely located user can view live realtime images of a loved one's gravestone by operating a computer operatively connected to a camera proximate the gravestone. In an alternative embodiment, recordings (audio and/or video) involving the deceased loved one are stored on a recording and audio/video display device such as a computer, DVD player, or video tape player proximate the gravestone. The recordings can be accessed by controls proximate the audio/video display device or by a remote control device carried by a user.

The power source is located proximate the gravestone and may be any power source however is typically selected from the group consisting of a solar panel, a battery, a mains power source, a fuel cell, a galvanic power source, and any other external power source. The galvanic power may be a derived from a circuit including the housing, camera hardware, and the ground on which the housing is mounted. The battery may be a primary battery (non-rechargeable) or a secondary battery (rechargeable) battery. A solar panel may be any type commercially available or any type constructed by a user. Useful solar panels typically include solar cells based on silicon, although thin film solar cells or peel-and-remove solar cells are also suitable. A mains power source may depend on the country in which the system is set up, for example 110 volts, 60 cycles in the United States and 220 volts and 50 cycles in Europe and many countries. Three cycle power is feasible as well.

The internet connection may be or involve at least one selected from the group consisting of telephone modem, DSL, GSM, WiFi, wireless internet, cellular phone, T1 line, cable internet, and combinations thereof.

The several components set forth hereinabove may be protected from the weathering and the sun by a housing. The housing may at least partially contain at least some of the camera, power source and at least part of the internet connection. The aforementioned components are typically operatively connected to one another within the housing. The housing may have the appearance of a footstone similar to the appearance of the gravestone. The footstone may be weatherproof and may be anchored securely to the ground or other foundation. The footstone may be of any construction such as stone, concrete, wood, metal, and plastic, including injection molded plastic. Combinations of the foregoing are also envisioned.

The system includes a website, housed on a server remotely located from either the camera and power source as well as remotely from the computer. The website may also include a user interface protected by at least a username and password, and security (such as secure sockets layer (SSL) with 64, 128 or 256 bit encryption; i.e., https:, that allows access to features only to a user having a username and password. The website may house a virtual storefront on which virtual or tangible items and services can be purchased. The storefront portion of the website may require username and password for access or may be accessed without a username and password. A user may set up an account, however one is not needed to purchase virtual or tangible goods or services.

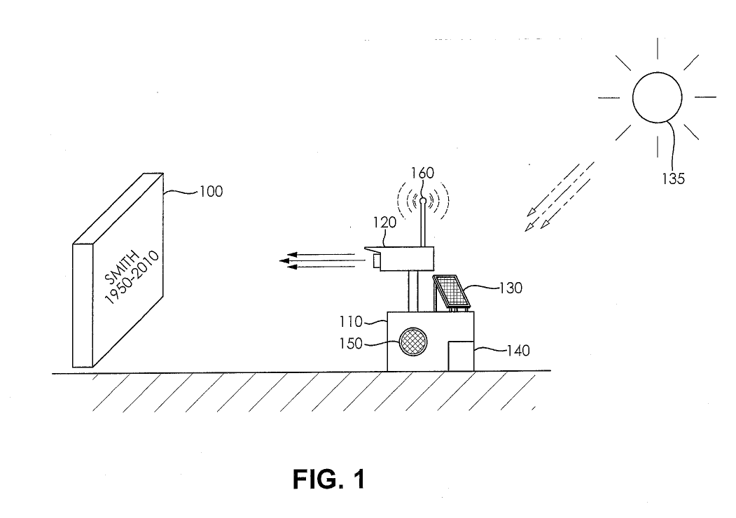

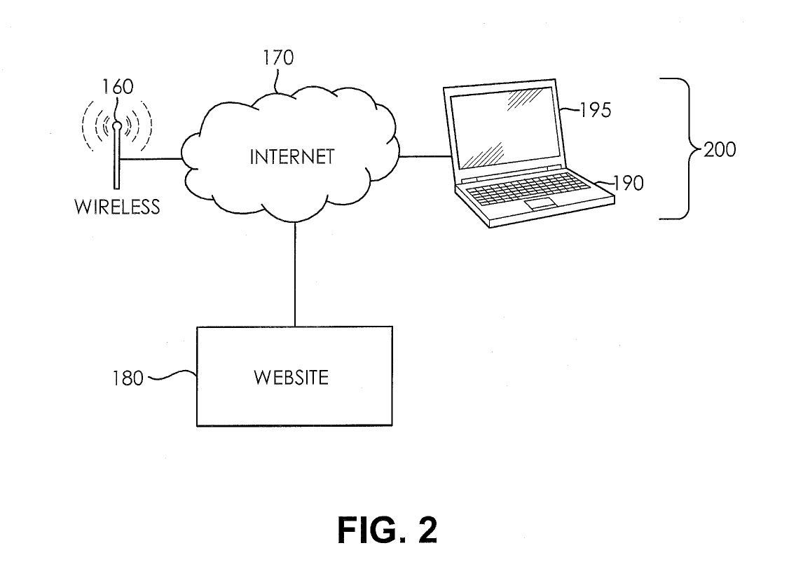

By entering the proper commands or choosing a command from a list of commands, on the website, a user can at least partially control at least one setting of the camera. The camera setting that may be controlled may include camera focus, camera direction, and camera zoom. The camera may also include a microphone or a light source such as a LED light. Referring to FIGS. 1 and 2, the camera 120 can be controlled to take snapshots either locally or remotely through wireless transceiver 160, which connects to the internet 170, which connects to a website 180. The information on the website may be communicated through the internet to a computer 200 and such information may be displayed on monitor or video display 195. A user may enter commands into website 180 through computer 200 using keyboard 190 to cause the camera to take still photos or video.

A video screen may be located proximate the video camera or housing in order to display images chosen by a user regarding the deceased's life and not necessarily those captured by the camera. The speaker may play sounds also so associated. The images and sounds may be stored on a local player within the housing such as a DVD or CD player or a computer, or may be played back from the website 180.

The invention further provides a method of transmitting images and sounds from a gravestone area to a user comprising: (a) providing a camera in the vicinity of a gravestone, (b) providing and operatively connecting a power source, speaker, wireless internet transceiver, and camera, in a housing proximate the gravestone, (c) providing a computer and internet connection, (d) operating the camera to perceive and at least temporarily store images of the gravestone and its surroundings, (e) transmitting images from the camera through the wireless internet transceiver to the internet, and (f) operating a website operatively connected to the internet in order to display images perceived by the camera to a user.

In the method, the wireless internet transceiver may be integral to the camera. The power source may be selected from the group consisting of a solar panel, a battery, and a mains power source. The power source may be a battery that is a rechargeable battery.

An embodiment of the method includes a virtual store on the website as disclosed elsewhere herein.

The website may also house or have access to social networking software to enable users to connect and network through the site. The website allows users, properly authenticated and paid for, to communicate with one another, share photos, files, video clips, or audio clips through the network.

Each user may have a customizable web page through which the user can solicit donations for people that cannot afford the burial and services. The customizable page that user makes is can be configured to upload images, videos, and music to give it a special place for the user to make for their loved one. The customizable pages may be created using any major world language.

Once registered, the user has the option to link pages among family members (i.e., related persons) in essence to build an online virtual family tree.

The method may also include at least partial control of at least one setting of the camera, such as camera focus, camera direction, and camera zoom. The camera may also include a microphone.

Referring to FIGS. 1 and 2, in an embodiment of the invention, a gravestone 100 is viewed by camera 120 at least partially housed in housing 110. Housing 110 also includes solar panel 130, power source 140 and speaker 150. A video screen (not shown, but which may take the place of speaker 150 or be provided in addition to the speaker) may also be included. Solar panel 130 and power source 140 are electrically connected to camera 120 and speaker 150 and video screen 155. Power source 140 may include a battery to store excess energy produced by solar panel 130. Solar panel 130 receives light energy from sun 135. Electricity produced by solar panel 130 may be used by any or all of video camera 120, speaker 150, the video screen or wireless transceiver 160.

Further, camera 120 may include a wireless transceiver 160 that allows communication between the camera and the internet. Wireless transceiver 160 may be physically located on or inside camera 120, and connects to the internet 170, which in turn connects to a website 180. The information on the website may be communicated through the internet to a computer 200 and such information, if graphical may be displayed on monitor or video display 195.

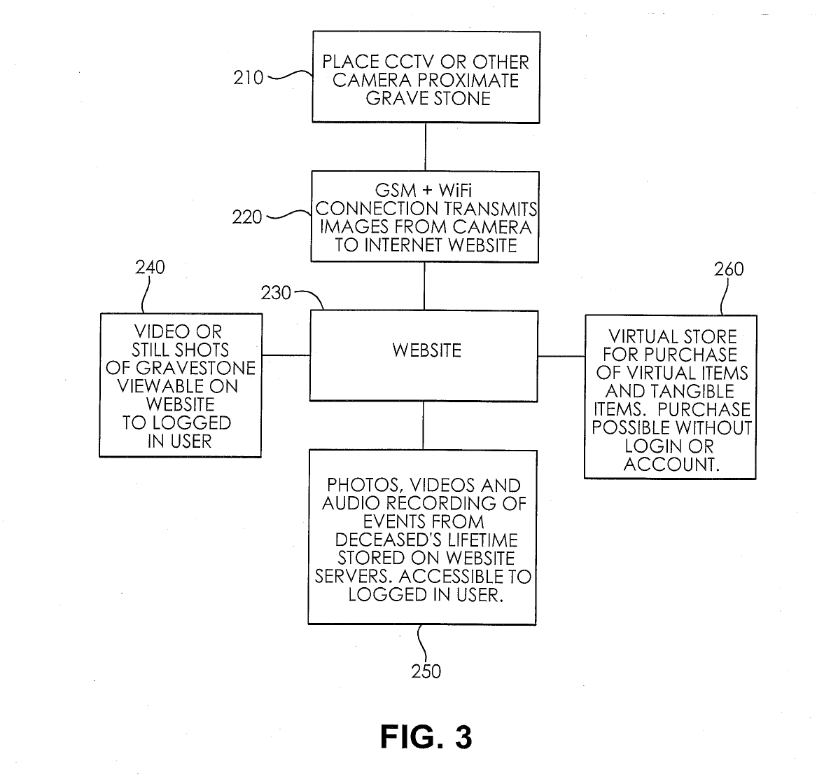

Another embodiment of the invention is depicted in the conceptual diagram in FIG. 3. This embodiment includes, 210, placing a closed circuit television or other camera to view a gravestone. Element 220 describes that the camera is equipped with a WiFi and/or GSM (wireless telephone) capability in order to transmit images or videos to the internet and to a website. The website 230 has several capabilities. Video or still shots taken by the camera are viewable on a computer logged into the website 240. In another aspect of the invention, 260, the website, which may be angelbook.com or myangelbook.com or myserenitycam.com, includes a virtual store which can be used to purchase virtual items or tangible items. While the portion of the website involving viewing the gravestone or preloaded video and/or audio of the events from the life of the deceased, 250, requires a username and password, associated with the payment of a one-time or periodic (i.e., monthly) fee, the virtual store can be accessed, and the items can be purchased without a username and password or account setup. However an account may be set up.

Yet another embodiment of the invention is an embodiment of the invention is a method of presenting at least one of images and sounds of a person comprising: (a) recording at least one of images and sounds of a person, (b) storing the at least one of images and sounds on a server accessible to the internet, (c) providing and operatively connecting together a power source, at least one of a speaker and a video screen, and wireless internet transceiver proximate a gravestone, (d) providing a control switch by which a user may control the playback of at least one of a speaker and video screen, (e) providing a website, to which the computer, at least one of a speaker and a video screen and a computer are operatively connected, and (f) operating (1) the control switch or (2) the website to command the server to play back the at least one of images and sounds either on the computer screen or on the at least one of speaker and video screen proximate the gravestone.

Audio and/or video recorded from the course of a person's life may be stored on a computer server. After the passing of the person, loved ones may access such audio and or video either at the gravesite by operation of a control switch or panel, which may be a standard computer keyboard or by operation of a website to which the computer server is connected. A loved one my view audio and/or video from events in the person's life on a computer connected to the website.

1. A system for remotely perceiving images and sounds associated with a gravestone, comprising:
a. a gravestone,
b. a power source,
c. a camera,
d. a wireless internet transceiver,
e. a video screen,
f. a speaker,
g. a computer,
h. a database,
i. a website, and
j. an internet connection,
wherein the power source, speaker, wireless internet transceiver, and camera, are operatively connected together in a housing proximate the gravestone,
wherein the computer, video screen, database, website and camera are operatively connected, such that commands entered into the computer are transmitted through at least one of the website and the wireless internet transceiver to effect control of the camera,
wherein the database is capable of storing snapshots or videos perceived by the camera and transmitted through at least one of the website and the wireless internet transceiver to the computer and the attached video screen.

2. The system of claim 1, further including a remote control capable of controlling at least one of the camera, the light source, the speaker and the video screen.

3. The system of claim 1, further including a light source.

4. The system of claim 1 wherein the operative connection among at least the camera, power source and wireless internet transceiver is a motherboard.

5. The system of claim 1, wherein the power source includes at least one selected from the group consisting of a solar panel, a battery, and a mains power source.

6. The system of claim 1, wherein the internet connection is at least one selected from the group consisting of GSM, WiFi, wireless internet, cellular phone, T1 line, cable internet, and combinations thereof.

7. The system of claim 1, further comprising a housing, wherein the camera, power source and at least part of the internet connection are housed in the housing and operatively connected to one another.

8. The system of claim 1, wherein the website houses a virtual store on which tangible or virtual items and services can be purchased.

9. The system of claim 1, wherein the website includes or has access to social networking software enabling a first user to interact with at least a second user through at least one of instant messages, message boards, and emails accessible only through the website or social networking software, wherein the website or social networking software enables the at least two users to share at least one of photos, images, videos, and audio clips.

10. The system of claim 9, wherein the social networking software includes or has access to point-of-sale software enabling a user to solicit and receive monetary donations.

11. The system of claim 9, wherein at least one of the website and social networking software is capable of linking at least one of uploaded photos, images, videos and audio clips uploaded by related persons to form a virtual family tree.

12. A method of transmitting images and sounds from a gravestone area to a user comprising:
a. providing a camera in the vicinity of a gravestone,
b. providing and operatively connecting together a power source, speaker, wireless internet transceiver, and camera, in a housing proximate the gravestone,
c. providing an internet connection, to which the camera and a computer are operatively connected,
d. operating the camera to perceive and at least temporarily store images of the gravestone,
e. transmitting images from the camera through the wireless internet transceiver to the internet, and
f. operating a website operatively connected to the internet in order to transmit and display images perceived by the camera to the computer making them visible to the user.

13. The method of claim 12, wherein the wireless internet transceiver is integral to the camera.

14. The method of claim 12, wherein the power source is selected from the group consisting of a solar panel, a battery, and a mains power source.

15. The method of claim 12, wherein the internet connection is at least one selected from the group consisting of GSM, WiFi, wireless internet, cellular phone, T1 line, cable internet, and combinations thereof.

16. The method of claim 12, further comprising a housing, wherein the camera, power source and at least part of the internet connection are housed in the housing and operatively connected to one another.

17. The method of claim 12, wherein the website houses a virtual store on which tangible items and services can be purchased.

18. The method of claim 12, wherein through the website a user can at least partially control at least one setting of the camera selected from the group consisting of power on, power off, record video, record snapshot, camera focus, camera direction, and camera zoom.

19. The method of claim 12, wherein a remote control device is further provided, and wherein the remote control at least partially controls a camera setting selected from the group consisting of power on, power off, record video, record snapshot, camera focus, camera direction, and camera zoom.

20. A method of presenting at least one of images and sounds of a person comprising:
a. recording at least one of images and sounds of a person,
b. storing the at least one of images and sounds on a server accessible to the internet,
c. providing and operatively connecting together a power source, at least one of a speaker and a video screen, and wireless internet transceiver proximate a gravestone,
d. providing a control switch by which a user may control the playback of at least one of a speaker and video screen,
e. providing a website, to which the computer, at least one of a speaker and a video screen and a computer are operatively connected, and
f. operating (1) the control switch or (2) the website to command the server to play back the at least one of images and sounds either on the computer screen or on the at least one of speaker and video screen proximate the gravestone.
